(19) United States
(12) Patent Application Publication
(10) Pub. No.: US 2014/0311798 A1
(43) Pub. Date: Oct. 23, 2014

(54) ELECTRIC WIRE CONNECTION STRUCTURE AND ELECTRIC WIRE CONNECTION METHOD

(71) Applicant: Yazaki Corporation, Tokyo (JP)

(72) Inventors: Yuki NUMATA, Makinohara-shi (JP); Ayako SHIMIZU, Makinohara-shi (JP); Shinji MIYAZATO, Makinohara-shi (JP)

(73) Assignee: Yazaki Corporation, Tokyo (JP)

(21) Appl. No.: 14/254,476

(22) Filed: Apr. 16, 2014

(30) Foreign Application Priority Data
Apr. 17, 2013 (JP) 2013-086197

(51) Int. Cl. H02G 15/06; H01R 43/02

(52) U.S. Cl. CPC H02G 15/06; H01R 43/0207
USPC 174/75 R; 228/111

(57) ABSTRACT

A structure of an electric wire for connection includes a conductor end portion of the electric wire comprised of a plurality of core wires. The conductor end portion is compressed by press-forming to pressurize from the side of an outer peripheral surface thereof toward the side of the axis thereof. A tapered surface is formed by the press-forming on the outer peripheral surface of at least a tip side of the conductor end portion, which inclines toward a direction crossing an axial direction of the conductor end portion. The conductor end portion on which the tapered surface is formed is electrically connected with a connected portion by ultrasonic joining.

### CROSS REFERENCE TO RELATED APPLICATION

This application claims benefit of priority under 35 U.S.C. §119 to Japanese Patent Application No. 2013-086197, filed on Apr. 17, 2013, the entire contents of which are incorporated by reference herein.

### BACKGROUND OF THE INVENTION

1. Field of the Invention

The present invention relates to a structure of an electric wire for connection and a method for connecting an electric wire, which is applied to various apparatuses, with a connected portion of a metal terminal or the like.

2. Description of the Related Art

As a structure for electrically connecting an electric wire, which is a strand wire, or the like, made by unifying a plurality of core wires, with a connected portion of a connection terminal (metallic terminal), or the like, Patent Literatures (Japanese Patent Application Laid-Open Publications 2006-172927, 2004-95293, 2009-277445, and 2011-60726) have proposed a structure where a conductor end portion, which is exposed from an outer covering of an electric wire end portion (such as a conductor end portion exposed by removing an insulating covering of an electric wire), is connected with a connected portion at a predetermined connection position of the connected portion by ultrasonic joining.

In order to prevent the occurrence of a burr and a snap of core wires at a conductor end portion during ultrasonic joining, it is desirable to compress the conductor end portion in advance by press-forming in accordance with the shape of a connection position of a connected portion, thereby enhancing reliability (improvement of joining strength and prevention of short circuit) of an electric connection between the conductor end portion and the connection terminal.

### SUMMARY OF THE INVENTION

The present invention has an object to provide a structure of an electric wire for connection and a method for connecting an electric wire capable of enhancing reliability of an electric connection between a conductor end portion and a connected object by improving close adhesion of respective core wires of the conductor end portion, thereby restraining the conductor end portion from coming loose. This prevents the occurrence of a burr or a snap of core wires at the conductor end portion.

According to a first aspect of the present invention, there is provided a structure of an electric wire for connection, the electric wire comprising: a conductor end portion that is an end portion of the electric wire comprised of a plurality of core wires, wherein the conductor end portion is to be compressed by press-forming to pressurize from the side of an outer peripheral surface of the conductor end portion toward the side of an axis of the conductor end portion and to be electrically connected with a connected portion by ultra joining, wherein the conductor end portion is formed with one or more tapered surfaces on the outer peripheral surface of at least a tip side of the conductor end portion by the press-forming, the tapered surfaces inclining toward a direction crossing an axial direction of the conductor end portion.

According to a second aspect of the present invention, there is provided a method for connecting an electric wire comprising: compressing a conductor end portion of the electric wire, which is comprised of a plurality of core wires, by a press-forming apparatus that pressurizes from the side of an outer peripheral surface of the conductor end portion toward the side of an axis of the conductor end portion; and electrically connecting the conductor end portion with a connected portion by ultrasonic joining, wherein the press-forming apparatus includes: a width regulation mold that has a linear groove into which the conductor end portion is to be fitted, the regulation mold regulating the width in a diameter direction of the conductor end portion by an inner wall surface of the linear groove; and a press-contact mold that has a press-contact surface, the press contact surface press-contacting with the outer peripheral surface of the conductor end portion, which is fitted into the linear groove, from a direction of an opening side of the linear groove, wherein at least one of the inner wall surface of the linear groove of the width regulation mold and the press-contact surface of the press-contact mold is formed with a protrusion, the protrusion protruding in a direction to which the conductor end portion is pressurized and having a tapered surface at a position opposing to the outer peripheral surface of at least a tip side of the conductor end portion fitted into the linear groove, the tapered surface inclining toward a direction crossing an axial direction of the conductor end portion.

According to a third aspect of the present invention, there is provided a method for connecting an electric wire comprising: compressing a conductor end portion of the electric wire, which is comprised of a plurality of core wires, by a press-forming apparatus that pressurizes from the side of an outer peripheral surface of the conductor end portion toward the side of an axis of the conductor end portion; and electrically connecting the conductor end portion with a connected portion by ultrasonic joining, wherein the press-forming apparatus includes: a press-contact mold that has a plurality of mold members, wherein the plurality of mold members have a plurality of press-contact surfaces, respectively, which press-contact with the outer peripheral surface of the conductor end portion placed in the press-contact mold from positions arranged in a circumferential direction of the conductor end portion, the plurality of press-contact surfaces simultaneously pressurize the outer peripheral surface of the conductor end portion, at least one of the plurality of press-contact surfaces is formed with a tapered surface at a position opposing to the outer peripheral surface of at least a tip side of the conductor end portion placed in the press-contact mold, the tapered surface inclining toward a direction crossing an axial direction of the conductor end portion.

According to a structure of an electric wire for connection and a method for connecting an electric wire of the present invention, it is possible to enhance reliability of an electric connection between a conductor end portion and a connected object by improving close adhesion of respective core wires of the conductor end portion, thereby restraining the conductor end portion from coming loose. This prevents the occurrence of a burr and a snap of core wires at the conductor end portion.

### BRIEF DESCRIPTION OF THE DRAWINGS

FIG. 1A is a perspective view of a conductor end portion according to a first embodiment.

FIG. 1B is a side view of the conductor end portion according to the first embodiment.

FIG. 2 is a schematic diagram illustrating press-forming according to the first embodiment.

FIG. 3A is a schematic diagram illustrating a state before compression by the press-forming according to the first embodiment.

FIG. 3B is a schematic diagram illustrating a state during the compression by the press-forming according to the first embodiment.

FIG. 4 is a schematic diagram illustrating a structure for connection according to the first embodiment.

FIG. 5A is a perspective view of a conductor end portion according to a second embodiment.

FIG. 5B is a side view of the conductor end portion according to the second embodiment.

FIG. 5C is a front view of the conductor end portion according to the second embodiment.

FIG. 6A is a schematic diagram illustrating a state before compression by press-forming according to the second embodiment.

FIG. 6B is a schematic diagram illustrating a state during the compression by the press-forming according to the second embodiment.

FIG. 7A is a schematic diagram illustrating a state before compression by another press forming according to the second embodiment.

FIG. 7B is a schematic diagram illustrating a state during the compression by the press-forming according to the second embodiment.

FIG. 8 is a schematic diagram illustrating a structure for connection according to the second embodiment.

FIG. 9 is a schematic diagram illustrating a widely used electric wire.

FIG. 10A is a schematic diagram illustrating a state before press-forming according to widely used press-forming.

FIG. 10B is a schematic diagram illustrating a state after the press-forming according to the widely used press-forming.

FIG. 11A is a schematic diagram illustrating a state before widely used ultrasonic joining.

FIG. 11B is a schematic diagram illustrating a state after the widely used ultrasonic joining.

### DESCRIPTION OF THE PREFFERED EMBODIMENT

A structure of an electric wire for connection and a method for connecting an electric wire according to the present invention is capable of electrically connecting a conductor end portion of an electric wire, which is made by unifying a plurality of core wires, with a connected portion of a connection terminal, or the like, by ultrasonic joining. The conductor end portion has a tapered surface on an outer peripheral surface of at least a tip side of the conductor end portion, which is formed by compressing the conductor end portion through press-forming. The tapered surface inclines toward a direction crossing an axial direction of the conductor end portion.

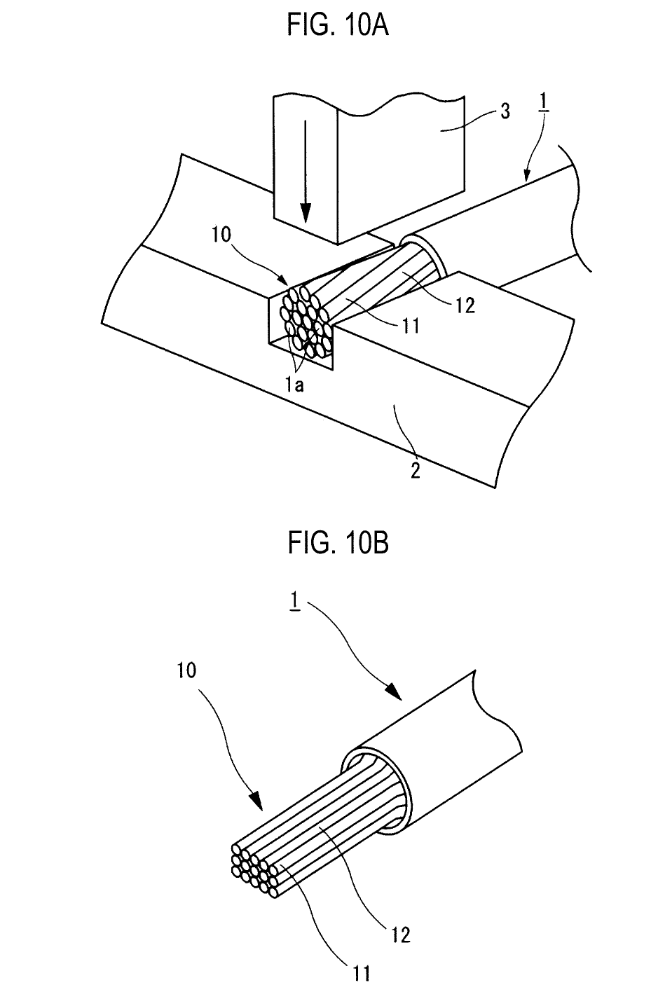

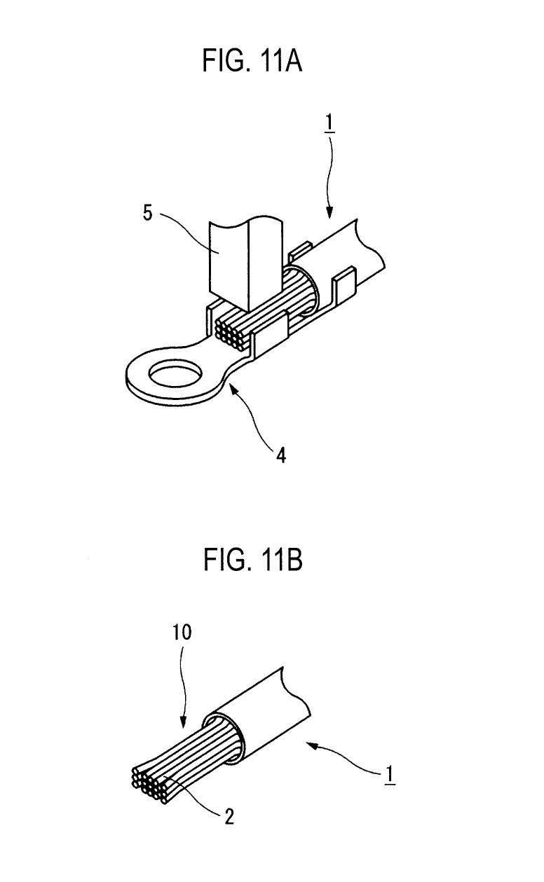

In a conventional structure for connection, at an end portion of an electric wire 1 comprised of a plurality of core wires 1a as shown in FIG. 9, a conductor end portion 10 exposed from an outer covering 1b (for example, conductor end portion 10 exposed by removing an insulating covering) is press-formed by a press-contact mold 3 while fixed by a width regulation mold 2 as shown in FIG. 10A. Thereby, the conductor end portion 10 is compressed in the shape of a nearly flat plate as shown in FIG. 10B. Then, as shown in FIG. 11A, while the compressed conductor end portion 10 is placed in a predetermined connection position of a connected portion 4, the conductor end portion 10 has an outer peripheral surface 12 press-contacted with a pressurization vibration horn 5 of an ultrasonic joining apparatus for pressurization and vibration, so that the conductor end portion 10 and the connected portion 4 are joined by ultrasonic. However, since the conductor end portion 10 vibrates during the ultrasonic joining, if the conductor end portion 10 comes loose on the side of a tip part 11 thereof, the conductor end portion 10 may have a burr and a snap of core wires at the tip part 11 thereof as shown in FIG. 11B. Therefore the reliability of the electric connection between the conductor end portion 10 and the connected portion 4 decreases, such as having a possibility of a decrease in joining strength or the occurrence of a short circuit.

On the other hand, according to the present embodiment, the conductor end portion is formed with a tapered surface, which inclines toward a direction crossing an axial direction of a conductor end portion, on the outer peripheral surface of at least a tip side of the conductor end portion. Thus, in comparison with the conventional connection structure without a tapered surface, the conductor end portion of the present embodiment is firmly compressed on the tip side thereof, so that the core wires at the tip part thereof adhere tightly each other. Therefore, the conductor end portion is restrained from coming loose, thereby preventing the occurrence of a burr and a snap of core wires at the conductor end portion. Thus, the reliability of an electric connection between the conductor end portion and the connected portion is enhanced.

As the reliability of the electric connection is enhanced (quality is improved) in this way, there is no need of an inspection process, and the like, in later processes, which results in cost reduction. Moreover, the reduction in work processes results in cost reduction of various managements and facilities in the process according to the ultrasonic joining.

It is possible to appropriately modify the structure of the electric wire for connection and the method for connecting the electric wire according to the present invention by applying common techniques in various arts including the electric wire art, the press-forming art, and the ultrasonic joining art, as long as a conductor end portion formed with a tapered surface is electrically connected with a connected portion by ultrasonic joining.

### (Tapered Surface)

In the present embodiment, as long as a surface is in a tapered shape, which inclines toward a direction crossing the axial direction of the conductor end portion, and formed on the outer peripheral surface of at least a tip side of the conductor end portion, the number of tapered surfaces is not limited and may be one or plural. At the area of the conductor end portion, where the tapered surface is formed, a distance between the tapered surface and the axis of the conductor end portion is reduced. Thereby, the amount of compression is enlarged, and the close adhesion among the core wires is increased.

As long as the tapered surface inclines toward a direction crossing the axial direction of the conductor end portion, a direction of the inclination of the tapered surface is not limited. For example, the tapered surface may incline so as to come close to the axis of the conductor end portion as the tapered surface comes close to the tip side of the conductor end portion (hereinafter referred to as tip direction inclination). The tapered surface may also incline so as to come close to the axis of the conductor end portion as the tapered surface comes close to the root side of the conductor end portion (hereinafter referred to as root direction inclination). Moreover, both of the tapered surface of tip direction inclination and the tapered surface of root direction inclination may be formed on the outer periphery surface of at least the tip side of the conductor end portion (see first embodiment described below).

In a case of forming a plurality of tapered surfaces along a circumferential direction of the conductor end portion, the plurality of tapered surfaces is arranged at equal intervals along the circumferential direction. According to the structure, the tip side of the conductor end portion can be equally compressed with ease. As a concrete example, in a case of forming two tapered surfaces, the two tapered surfaces are arranged to face each other across the axis of the conductor end portion. Moreover, when the plurality of tapered surfaces is formed in succession along a circumferential direction of the conductor end portion (for example, the tip side of the conductor end portion is formed in a tapering cone shape), the tip side of the conductor end portion can be equally compressed with ease.

### (Press-Forming)

As long as a press-forming method is capable of forming a tapered surface on a conductor end portion through press-forming, various methods can be applied. For example, in a case of using a plurality of molds for press-forming, various molds are applied appropriately, such as a width regulation mold for regulating the width in a diameter direction of the conductor end portion and a press-contact mold for press-contacting with the outer peripheral surface of the conductor end portion. At least one of these molds is formed with a tapered surface, which inclines toward a direction crossing the axial direction of the conductor end portion, at a position opposing to the outer peripheral surface of at least the tip side of the conductor end portion. Thereby, in the press-forming, when a press-contact surface of the mold (press-contact surface formed with the tapered surface) press-contacts with the outer peripheral surface of the conductor end portion, the shape of the press-contact surface of the mold is reflected on the outer peripheral surface of the conductor end portion. This forms the tapered surface on the outer peripheral surface of the conductor end portion.

As a width regulation mold, there is mentioned a structure that has a linear groove into which the conductor end portion is fitted. The structure regulates the width in a diameter direction of the conductor end portion, which is fitted into the linear groove, by inner wall surfaces of the linear groove. The shape of the linear groove (for example, the width of the linear groove) can be appropriately set in accordance with the shape of the conductor end portion or a connected portion. As a concrete example, there is mentioned a linear groove that has a flat bottom wall and two side walls which extend from the bottom wall in a perpendicular direction.

As a press-contact mold, there is mentioned a structure that has a press-contact surface which press-contacts with the outer peripheral surface of the conductor end portion. The structure is also formed with a tapered surface, which inclines toward a direction crossing the axial direction of the conductor end portion, at a position opposing to the outer peripheral surface of at least the tip side of the conductor end portion.

A press-forming method is not limited to a combination of the width regulation mold and the press-contact mold applied in the press-forming of the first embodiment, which will be described later. Only the press-contact mold may be applied to the press-forming. As a concrete example, there is mentioned a press-contact mold capable of moving a plurality of mold members from respective positions spaced each other in a circumferential direction on the side of the outer periphery surface of the conductor end portion toward the side of the axis of the conductor end portion. There is also mentioned a press-contact mold cable of simultaneously pressurizing the outer peripheral surface of the conductor end portion by a plurality of mold members having press-contact surfaces, respectively, which are arranged along a circumferential direction with respect to the outer peripheral surface of the conductor end portion (for example, press-contact surfaces which press-contact at adjacent positions or at separated positions by a predetermined distance). As a concrete example, there is mentioned a structure that simultaneously pressurizes across the circumference of the outer periphery surface as in the second embodiment, which will be described later.

### (Others)

As an ultrasonic joining method, various methods can be applied as long as the method is for joining the conductor end portion with the connected portion for an electric connection. For example, there is mentioned a method using a pressurization vibration horn which gives ultrasonic vibrations on the conductor end portion placed at a connection position of the connected portion, while pressurizing the same (see method disclosed in Patent Literatures 1 to 4).

Since the conductor end portion and the connected portion are electrically connected with each other by ultrasonic joining, a connection terminal (metallic terminal) made of an electrical conducting material such as copper is preferable as the connected portion. The connected portion is however not limited to a connection terminal made of an electrical conducting material.

The shape of the press-formed conductor end portion may be any shape as long as the tapered surface is formed thereon. Other areas than the tapered surface of the conductor end portion may have various shaped cross sections including a rectangular cross section, a disc-shaped cross section, and an ellipse cross section, but not limited to these shapes.

Next, an example of a structure of an electric wire for connection and a method for connecting an electric wire according to the present embodiment will be described based on the first embodiment and the second embodiment. It is noted that the present invention is not limited to the first embodiment and the second embodiment. In the first embodiment and the second embodiment, detailed descriptions for the same elements in FIGS. 9 to 11 will be omitted by using the same reference numbers.

### First Embodiment 1

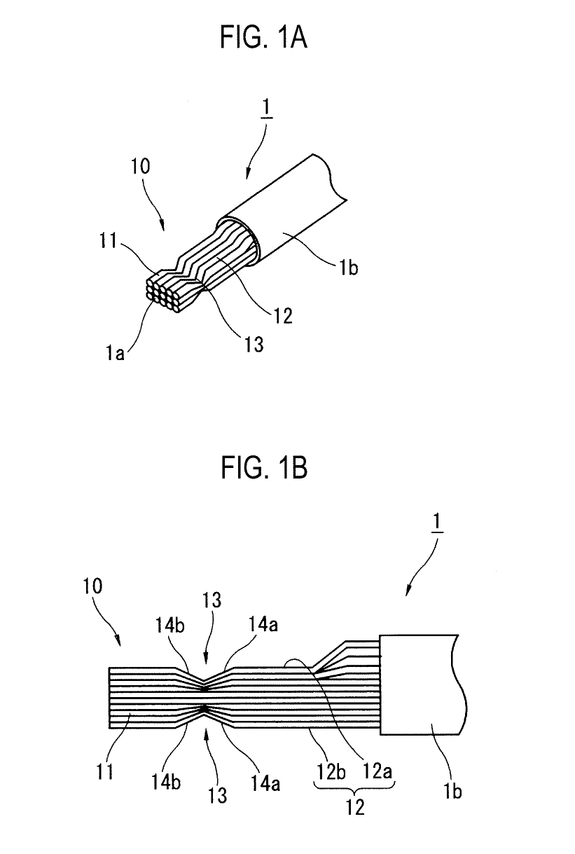

As shown in FIGS. 1A and 1B, a conductor end portion 10 of an electric wire 1 is compressed in the shape of a nearly flat plate (rectangular cross section) by press-forming to pressurize the conductor end portion 10 from a direction of the outer peripheral side toward a direction of the axial side. The press-forming makes grooves 13 and 13 on opposing surfaces 12a and 12b of an outer peripheral surface 12 of the conductor end portion 10 at a tip 11 side. Each of the grooves 13 and 13 has a shape depressed toward the axial side of the conductor end portion 10, and extends in a diameter direction of the conductor end portion 10. Each of the grooves 13 and 13 includes a tapered surface 14a which inclines toward the tip direction, and a tapered surface 14b which inclines toward the root direction as inner walls thereof. Each of the grooves 13 and 13 extends in the width direction of a diameter direction of the conductor end portion 10.

The conductor end portion 10 is compressed firmly at areas where the grooves 13 and 13 are formed in comparison with other areas, so that core wires 1a adhere tightly. In particular, at the closest area to the axis of the conductor end portion 10 in each of the grooves 13 and 13, that is an area where the tapered surfaces 14a and 14b cross each other, the conductor end portion 10 is compressed more firmly so that the core wires 1a adhere more tightly.

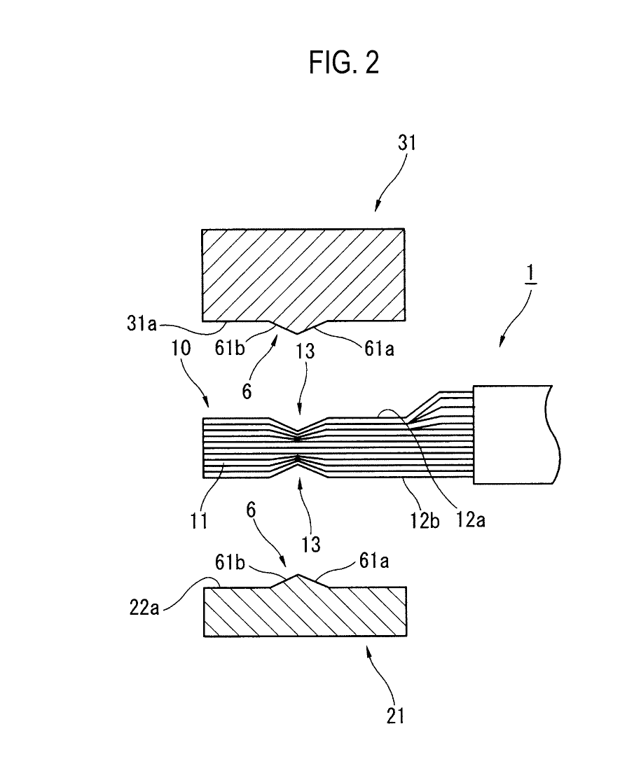

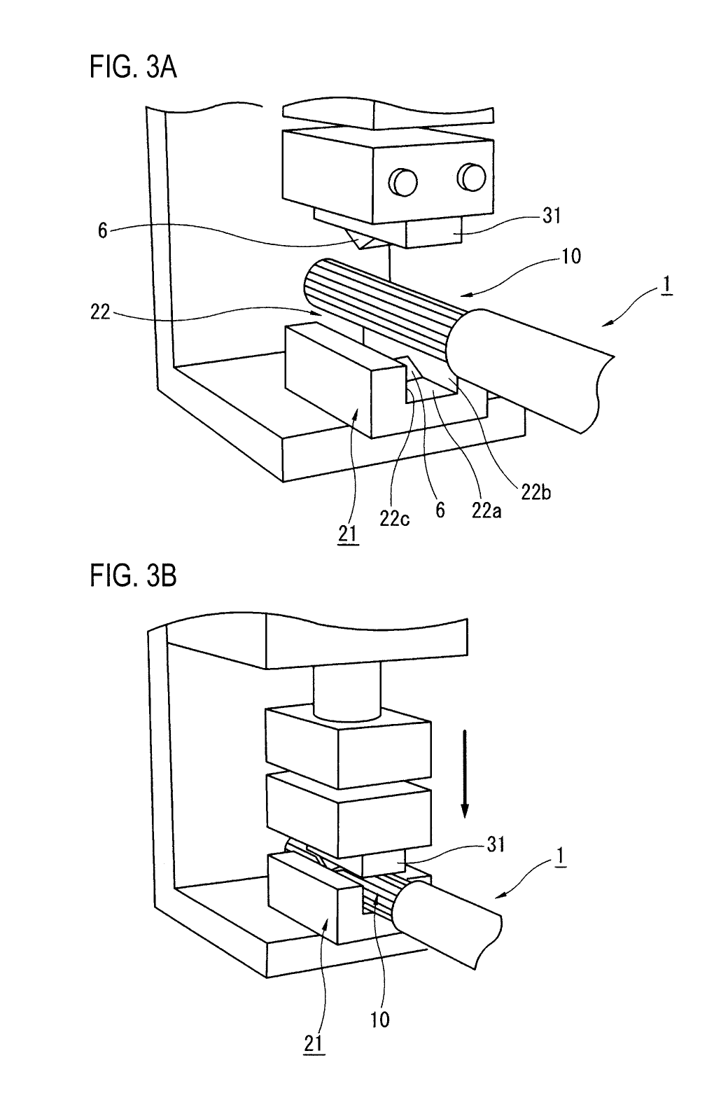

As shown in FIGS. 2, 3A, and 3B, the grooves 13 and 13 of the conductor end portion 10 are formed by pressing the conductor end portion 10 using a press-forming apparatus. The press-forming apparatus includes a width regulation mold 21 and a press-contact mold 31. The width regulation mold 21 includes a linear groove 22 into which the conductor end portion 10 is fitted. The linear groove 22 includes a flat bottom wall 22a, and side walls 22b and 22c provided to stand so as to extend in a perpendicular direction from the bottom wall 22a. The press-contact mold 31 is supported movable from a direction of the outer periphery surface side of the conductor end portion 10 toward a direction of the axial side of the conductor end portion 10.

As shown in FIG. 2, an inner wall surface (surface of the bottom wall 22a in the first embodiment) of the width regulation mold 21 and a press-contact surface 31a of the press-contact mold 31 are provided with protrusions 6 and 6, each of which has a triangle cross section, at positions opposing to positions on the surfaces 12a and 12b where the grooves 13 and 13 are to be formed while the conductor end portion 10 is placed on the press-forming apparatus. Each of the protrusions 6 and 6 protrudes in a direction to pressurize the conductor end portion 10, and extends in a linear shape in the width direction of a diameter direction of the conductor end portion 10. Each of the protrusions 6 and 6 is formed with a tapered surface 61a which inclines toward the tip direction and a tapered surface 61b which inclines toward the root direction.

As shown in FIG. 3A, the width regulation mold 21 and the press-contact mold 31 are arranged such that the flat bottom wall 22a of the linear groove 22 of the width regulation mold 21 and the press-contact surface 31a of the press-contact mold 31 face each other. As shown in FIG. 3B, while the conductor end portion 10 is fitted into the linear groove 22, the press-contact mold 31 is moved toward the width regulation mold 21, and thereby the conductor end portion 10 is compressed in the shape of a nearly flat plate. This forms the grooves 13 and 13 on the conductor end portion 10, each of which has the tapered surfaces 14a and 14b.

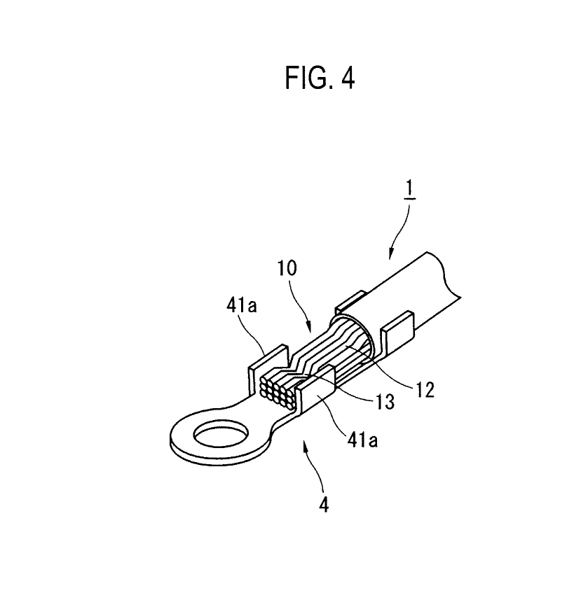

As shown in FIG. 4, the conductor end portion 10 on which the grooves 13 and 13 are formed, is placed at a connection position between side walls 41a and 41b of a connection terminal 4. In this state, by press-contacting the pressurization vibration horn 5 with the outer peripheral surface 12 of the conductor end portion 10 for pressurization and vibration, as same as the method in FIG. 11A, the conductor end portion 10 is electrically connected with the connection terminal 4.

It is noted that the appropriate forming of the grooves 13 and 13 on the outer peripheral surface 12 of the conductor end portion 10 reduces a contacting area of the pressurization vibration horn 5 with the outer peripheral surface 12 in the ultrasonic joining. Therefore, the grooves 13 and 13 reduce, for example, abrasion between the pressurization vibration horn 5 and the conductor end portion 10.

### Second Embodiment

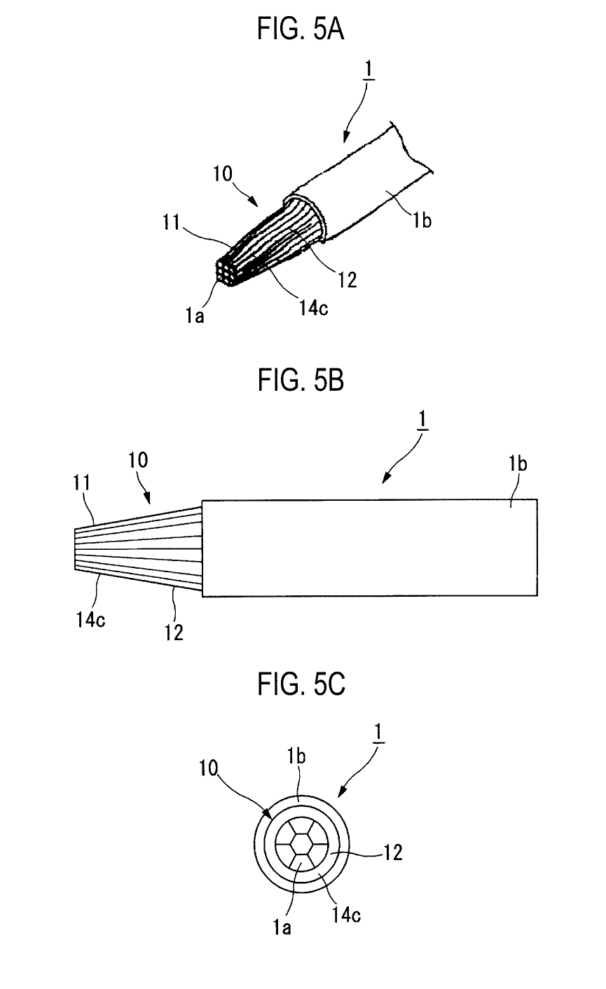

As shown in FIGS. 5A to 5C, a conductor end portion 10 of an electric wire 1 is compressed in a cone shape (rectangular cross section) by press-forming to pressurize the conductor end portion 10 from a direction of the outer peripheral side toward a direction of the axial side. The conductor end portion 10 is formed with a tapered surface 14c, which inclines toward the tip direction thereof, on an outer peripheral surface 12 in succession along a circumferential direction of the conductor end portion 10.

The conductor end portion 10 is compressed firmly at the area where the tapered surface 14c is formed, as same as the areas where the grooves 13 and 13 according to the first embodiment are formed, so that core wires 1a adhere tightly in comparison with other areas. In particular, at an area closest to the axis of the conductor end portion 10 on the tapered surface 14c, the conductor end portion 10 is compressed more firmly, so that the core wires 1a adhere more tightly. In the structure shown in FIGS. 5A to 5C, the conductor end portion 10 is equally compressed at the tip side. Thereby the core wires 1a are equally compressed, which enables an easy close adhesion as shown in FIG. 5C.

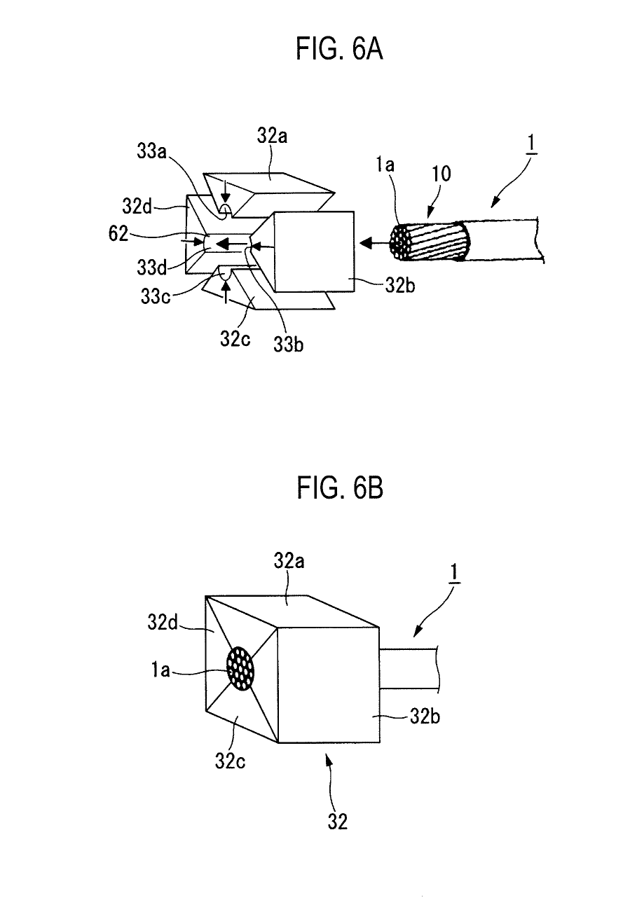

As shown in FIGS. 6A and 6B, the tapered surface 14c of the conductor end portion 10 is formed by pressing the conductor end portion 10 using a press-contact mold 32. The press-contact mold 32 includes a plurality of mold members 32a to 32d (four members in FIG. 6). The mold members 32a to 32d are moved from positions on the outer peripheral side of the conductor end portion 10, the positions being spaced from each other in a circumferential direction of the conductor end portion 10, toward a direction of the axial side of the conductor end portion 10. The mold members 32a to 32d include press-contact surfaces 33a to 33d which press-contact with the outer peripheral surface 12 of the conductor end portion 10 at positions adjacent each other in the circumferential direction, while the conductor end portion 10 is placed in the press-contact mold 32. The press-contact mold 32 simultaneously pressurizes the outer peripheral surface 12 of the conductor end portion 10 across the circumference thereof. Each of the press-contact surfaces 33a to 33d is formed with a tapered surface 62 which inclines toward the tip direction.

In a case of press-forming the conductor end portion 10 by the press-contact mold 32, the conductor end portion 10 is lain in an inner space surrounded by the mold members 32a to 32d which are arranged in a distributed state as shown in FIG. 6A. As shown in FIG. 6B, the mold members 32a to 32d are moved toward the axial side direction of the conductor end portion 10, thereby press-contacting the press-contact surfaces 33a to 33d with the outer peripheral surface 12. During the press-contacting, the press-contact surfaces 33a to 33d are made adjacent each other in a circumferential direction and press-contact with the conductor end portion 10, so that the conductor end portion 10 is compressed in a cone shape as shown in FIGS. 5A and 5B. This forms the tapered surface 14c on the outer peripheral surface 12.

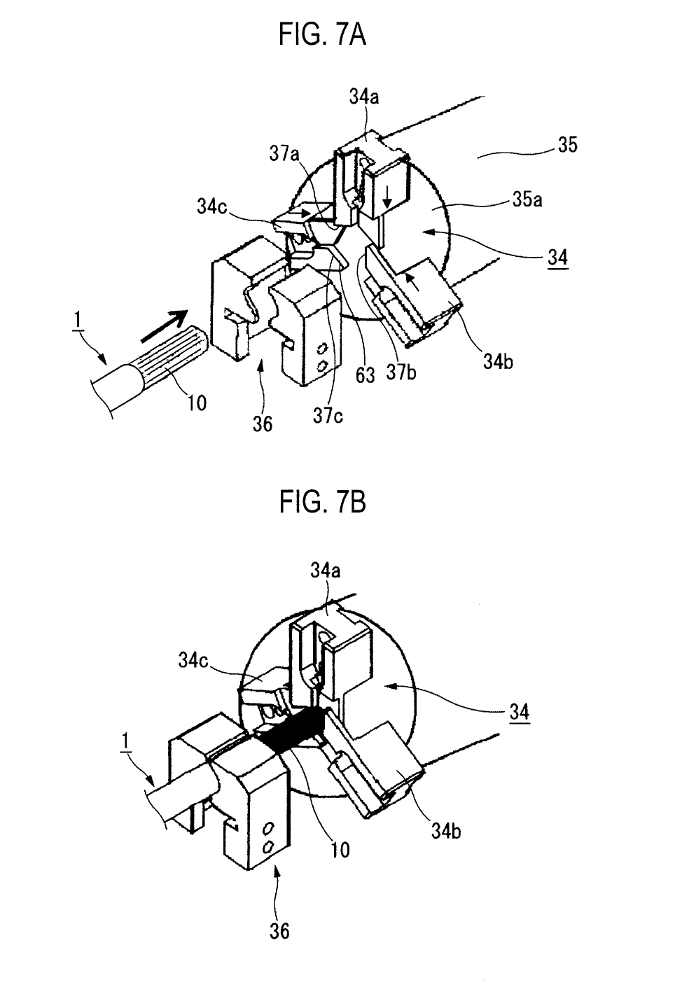

It is noted that the press-contact surfaces of the mold members of the press-contact mold are not limited to the structure such as the press-contact surfaces 33a to 33d shown in FIG. 6B, which press-contact with the outer peripheral surface 12 while being adjacent each other in a circumferential direction of the outer peripheral surface 12. For example, press-contact surfaces may have a structure such as press-contact surfaces 37a to 37c of mold members 34a to 34c of a press-contact mold 34 shown in FIGS. 7A and 7B, which are spaced by a predetermined distance in a circumferential direction of the outer peripheral surface 12. In the press-contact surface 34, a plurality of mold members 34a to 34c (three in FIG. 7) are supported by a support surface 35a which extends in a perpendicular direction of a support portion 35. For example, the mold members 34a to 34c are movably supported by the support surface 35a such that the mold members 34a to 34c press-contact with a conductor end portion 10 of an electric wire 1 held by a clamp 36 (movable along the support surface 35a toward a direction of the center of the support surface 35a). Each of the press-contact surfaces 37a to 37c of the mold members 34a to 34c, which press-contact with the outer peripheral surface 12, is formed with a tapered surface which inclines toward the tip direction (detailed description omitted), as same as that of the press-contact surfaces 33a to 33d of the mold members 32a to 32d in FIG. 6A. As shown in FIG. 7B, when the mold members 34a to 34c press-contact with the outer peripheral surface 12 while the mold members 34a to 34c are spaced by a predetermined distance in the circumferential direction, the outer peripheral surface 12 is formed with a plurality of tapered surfaces (not shown) spaced each other in the circumferential direction, which incline toward the tip direction.

It is noted that in the press-contact mold 34, the press-contact surfaces 37a to 37c of the mold members 34a to 34c may be made adjacent each other in the circumferential direction during press-contacting with the outer peripheral surface 12, by appropriately adjusting positions of the press-contact surfaces 37a to 37c with respect to the outer peripheral surface 12, as same as the press-contact surfaces 33a to 33d shown in FIG. 6A.

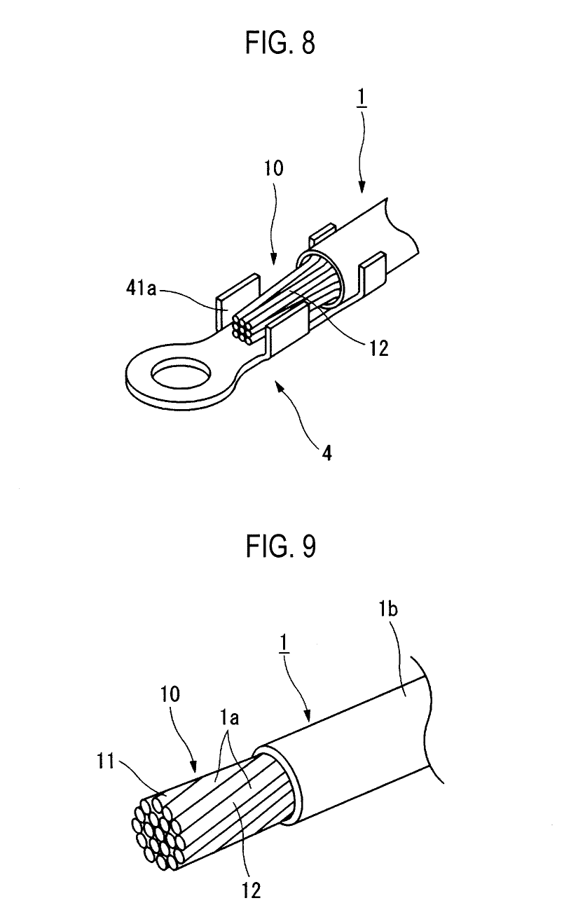

As shown in FIG. 8, while the compressed conductor end portion 10 is placed at a connection position between a pair of side walls 41a and 41a of a connection terminal 4, the compressed conductor end portion 10 is made electrically connected with the connection terminal 4 by press-contacting the pressurization vibration 5 with the outer peripheral surface 12 of the conductor end portion 10 for pressurization vibration as in the first embodiment.

As described above, the present embodiment describes concrete examples of a structure of an electric wire for connection and a method for connecting an electric wire of the present invention. Various modifications, and the like, are however possible within the scope of the technical idea of the present invention. These modifications, and the like, belong to the scope of claims.

What is claimed is:

1. A structure of an electric wire for connection, the electric wire comprising:
a conductor end portion that is an end portion of the electric wire comprised of a plurality of core wires, wherein the conductor end portion is to be compressed by press-forming to pressurize from the side of an outer peripheral surface of the conductor end portion toward the side of an axis of the conductor end portion and to be electrically connected with a connected portion by ultra joining,
wherein the conductor end portion is formed with one or more tapered surfaces on the outer peripheral surface of at least a tip side of the conductor end portion by the press-forming, the tapered surfaces inclining toward a direction crossing an axial direction of the conductor end portion.

2. The structure of the electric wire for connection according to claim 1, wherein
the conductor end portion includes the plurality of tapered surfaces that are formed at equal intervals on the conductor end portion along a circumferential direction of the conductor end portion.

3. The structure of the electric wire for connection according to claim 1, wherein
the conductor end portion includes the plurality of tapered surfaces that are formed in succession on the conductor end portion along a circumferential direction of the conductor end portion.

4. The structure of the electric wire for connection according to claim 1, wherein
the conductor end portion is press-formed in a cone shape that tapers on the tip side thereof by the press-forming.

5. A method for connecting an electric wire comprising:
compressing a conductor end portion of the electric wire, which is comprised of a plurality of core wires, by a press-forming apparatus that pressurizes from the side of an outer peripheral surface of the conductor end portion toward the side of an axis of the conductor end portion; and
electrically connecting the conductor end portion with a connected portion by ultrasonic joining,
wherein the press-forming apparatus includes:
a width regulation mold that has a linear groove into which the conductor end portion is to be fitted, the regulation mold regulating the width in a diameter direction of the conductor end portion by an inner wall surface of the linear groove; and
a press-contact mold that has a press-contact surface, the press contact surface press-contacting with the outer peripheral surface of the conductor end portion, which is fitted into the linear groove, from a direction of an opening side of the linear groove,
wherein at least one of the inner wall surface of the linear groove of the width regulation mold and the press-contact surface of the press-contact mold is formed with a protrusion, the protrusion protruding in a direction to which the conductor end portion is pressurized and having a tapered surface at a position opposing to the outer peripheral surface of at least a tip side of the conductor end portion fitted into the linear groove, the tapered surface inclining toward a direction crossing an axial direction of the conductor end portion.

6. The method for connecting an electric wire according to claim 5, wherein
the protrusion has a triangle cross section.

7. The method for connecting an electric wire according to claim 5, wherein
the protrusion is formed on each of the inner wall surface of the linear groove of the width regulation mold and the press-contact surface of the press-contact mold at positions opposing each other across the conductor end portion fitted into the linear groove.

8. A method for connecting an electric wire comprising:
compressing a conductor end portion of the electric wire, which is comprised of a plurality of core wires, by a press-forming apparatus that pressurizes from the side of an outer peripheral surface of the conductor end portion toward the side of an axis of the conductor end portion; and
electrically connecting the conductor end portion with a connected portion by ultrasonic joining,
wherein the press-forming apparatus includes:
a press-contact mold that has a plurality of mold members,
wherein the plurality of mold members have a plurality of press-contact surfaces, respectively, which press-contact with the outer peripheral surface of the conductor end portion placed in the press-contact mold from positions arranged in a circumferential direction of the conductor end portion,
the plurality of press-contact surfaces simultaneously pressurize the outer peripheral surface of the conductor end portion,
at least one of the plurality of press-contact surfaces is formed with a tapered surface at a position opposing to the outer peripheral surface of at least a tip side of the conductor end portion placed in the press-contact mold, the tapered surface inclining toward a direction crossing an axial direction of the conductor end portion.

9. The method for connecting an electric wire according to claim 8,
wherein the plurality of mold members are movable from positions spaced each other along a circumferential direction of the conductor end portion on the side of the outer peripheral surface toward the side of the axis of the conductor end portion.
